(19) United States
(12) Patent Application Publication
(10) Pub. No.: US 2014/0098786 A1
(43) Pub. Date: Apr. 10, 2014

(54) APPARATUS AND METHOD FOR CONTROLLING SESSION MOBILITY, AND APPARATUS AND METHOD FOR REGISTERING IP MULTIMEDIA SUBSYSTEM

(71) Applicant: ELECTRONICS AND TELECOMMUNICATIONS RESEARCH INSTITUTE, Daejeon (KR)

(72) Inventors: Jong Choul YIM, Daejeon (KR); Hyun Joo BAE, Daejeon (KR)

(73) Assignee: ELECTRONICS AND TELECOMMUNICATIONS RESEARCH INSTITUTE, Daejeon (KR)

(21) Appl. No.: 14/039,643

(22) Filed: Sep. 27, 2013

(30) Foreign Application Priority Data
Oct. 8, 2012 (KR) 10-2012-0111328

(51) Int. Cl. H04W 36/00

(52) U.S. Cl. CPC H04W 36/0011
USPC 370/331

(57) ABSTRACT

An individual IMS terminal acquires address and place information of a service discovery server present in the local IP network from an AP. Next, the individual IMS terminal may query the service discovery server to find out an SIP URL address of a sharing IMS terminal. When the individual IMS terminal finds out the sharing IMS terminal, its own IMS subscription information is transmitted to the sharing IMS terminal. The sharing IMS terminal is dynamically registered in the IMS depending on the received IMS subscription information. When the process ends, the sharing IMS terminal has the same IMS subscription information as the individual IMS terminal, such that the session mobility control provided by the IMS may be applied as it is.

### CROSS-REFERENCE TO RELATED APPLICATIONS

This application claims priority to and the benefit of Korean Patent Application No. 10-2012-0111328 filed in the Korean Intellectual Property Office on Oct. 8, 2012, the entire contents of which are incorporated herein by reference.

### TECHNICAL FIELD

The present invention relates to an apparatus and a method for controlling session mobility and an apparatus and a method for registering an IP multimedia subsystem. More particularly, the present invention relates to an apparatus and a method for performing a session mobility control function through an individual IMS terminal in an IP multimedia subsystem (IMS) environment and an apparatus and a method for performing IMS registration through a sharing IMS terminal.

### BACKGROUND ART

Currently, a mobile communication network provides a function of receiving a service through a communication network even in the user movement in the state in which a user carries a single terminal. In addition, recently, the development to a networking environment in which many apparatuses are connected with a network and a user may freely use the apparatuses during the user movement has been made. This means the development to the environment in which a user uses several terminals.

It is essential to support service continuity to provide a better service use experience to a user in the environment in which a user may use several terminals. The service continuity refers to seamlessly providing a currently progressing service to a user even though a current state of a user is changed, such as a change of a terminal and a change of an access network.

The service continuity is already supported by a terminal mobility control of a current mobile communication network. However, the terminal mobility is a method for changing an access network by a horizontal handoff or a vertical handoff under the premise that a user uses one terminal, such that the service continuity cannot be guaranteed only by the terminal mobility support in the environment that a user may use several terminals.

An IP multimedia subsystem (IMS) structure is a session control layer of an ALL IP based communication network and provides a voice calling service and various multimedia additional services. In the IMS structure, control, such as setting, changing, and releasing, and the like, of a session for various multimedia services is performed using an SIP protocol.

Recently, in 3GPP, a standardization operation for providing service continuity under the IMS structure is performed, through a session mobility control between two terminals by using the SIP protocol. However, an IMS (release 9) based communication network has the following limitations that limits a user experience.

First, all the apparatuses need to belong to the same communication operator network.

Second, all the apparatuses need to use a single IMS subscription.

In other words, all the terminals need to be a user's own terminals registered in the same communication operator network so that a user is supported by the service continuity.

According to the related art, in order to receive the session mobility service between the terminals provided in the IMS, IMS subscription information of an individual IMS terminal needs to be set in a sharing IMS terminal The sharing IMS terminal means a terminal that does not belong to individuals, but may be used by many people. For example, the sharing IMS terminal is a smart TV at home. The smart TV at home is an apparatus that does not belong to one person, but is shared by a family member. However, when the sharing terminal is dedicated to a single user by allowing the user A's IMS subscription information has been configured in the sharing terminal prior to real use in a static manner, any other family member cannot use the sharing terminal for service continuity.

According to the related art, an IMS based terminal discovery method and a method for controlling session mobility have a problem in a ubiquitous network environment in which many apparatuses are connected through a network and these apparatuses may be shared and used by many users.

### SUMMARY OF THE INVENTION

The present invention has been made in an effort to provide an apparatus and a method for registering an IMS and an apparatus and a method for controlling session mobility which find out a sharing IMS terminal capable of accessing an IMS based communication network and allow a specific user to temporarily use the sharing IMS terminal.

However, the object of the present invention is not limited to the foregoing matters and other objects that are not mentioned may be clearly understood to those skilled in the art from the following description.

An exemplary embodiment of the present invention provides an apparatus for controlling session mobility, including: an address information acquisition unit that acquires address information of a sharing IP multimedia subsystem (IMS) terminal available at a current location; an IMS subscription information transmission unit that transmits its own IMS subscription information to the sharing IMS terminal based on the address information of the sharing IMS terminal; and a session mobility control unit that moves a progressing session to the sharing IMS terminal when the sharing IMS terminal is dynamically registered in the IMS based on the IMS subscription information.

The address information acquisition unit may include: a server address information acquisition unit that accesses an access point (AP) to acquire address information of a service discovery server storing the information on sharing IMS terminals; and a terminal address information acquisition unit that queries whether there is the sharing IMS terminal connected with a local network relating to current location information while transmitting the current location information to the service discovery server, and when a reply that there is the sharing IMS terminal connected with the local network is received, that acquires address information of the sharing IMS terminal connected with the local network from the service discovery server.

The server address information acquisition unit may acquire location information along with the address information of the service discovery server.

The address information acquisition unit may acquire a session initiation protocol (SIP) URL as the address information of the sharing IMS terminal and the IMS subscription information transmission unit may transmit the IMS subscription information to the sharing IMS terminal by being included in an SIP message.

The apparatus for controlling session mobility may be included in an individual INS terminal accessed by a user.

The apparatus for controlling session mobility may be driven every time the location of the user is changed.

Another exemplary embodiment of the present invention provides a method for controlling session mobility, comprising: acquiring address information of a sharing IP multimedia subsystem (IMS) terminal available at a current location; transmitting its own IMS subscription information to the sharing IMS terminal based on the address information of the sharing IMS terminal; and moving a progressing session to the sharing IMS terminal when the sharing IMS terminal is dynamically registered in the IMS based on the IMS subscription information.

The acquiring of the address information may include: accessing an access point (AP) to acquire address information of a service discovery server storing the information on sharing IMS terminals; and acquiring address information of the sharing IMS terminal connected with the local network from the service discovery server, when a reply that there is the sharing IMS terminal connected with the local network is received, after querying whether there is the sharing IMS terminal connected with a local network relating to current location information while transmitting the current location information to the service discovery server.

In the acquiring of the address information, the location information may be acquired along with the address information of the service discovery server.

In the acquiring of the address information, a session initiation protocol (SIP) URL may be acquired as the address information of the sharing IMS terminal and in the transmitting of the IMS subscription information, the IMS subscription information may be transmitted to the sharing IMS terminal by being included in an SIP message.

The method for controlling session mobility may be performed in an individual IMS terminal accessed by a user.

The method for controlling session mobility may be performed every time the location of the user is changed.

Yet another exemplary embodiment of the present invention provides an apparatus for registering to an IMS, including: when IMS subscription information of an individual IMS terminal is received, a mode setting control unit that sets a passive mode as an active mode; and a user equipment (UE) unit that performs IMS registration when being set as the active mode.

The apparatus for registering to an IMS may further include: when the IMS subscription information is received, a mode setting processing unit that sets various information on a UE, a public user identity, and a private user identity based on the IMS subscription information, and the mode setting control unit may drive a timer when the IMS registration is performed and set the active mode to the passive mode when the IMS registration fails or the driving of the timer ends.

The mode setting processing unit may dynamically set IMS access information based on the IMS subscription information when the IMS subscription information is received, and the UE unit may register its own interface address information to the IMS where its own interface address shall be different from interface address of the individual terminal.

The UE unit may use a globally routable UA URI (GRUU) as the interface address information.

The apparatus for registering to an IMS may be included in a sharing IMS terminal.

Still another exemplary embodiment of the present invention provides a method for registering to an IMS, including: when IMS subscription information of an individual IMS terminal is received, a mode setting control step of setting a passive mode as an active mode; and a UE function step of performing IMS registration when the mode is set as the active mode.

The method for registering to an IMS may further include: when the IMS subscription information is received, a mode setting processing step of setting various information on a UE, a public user identity, and a private user identity based on the IMS subscription information, and in the mode setting control step, a timer may be driven when the IMS registration is performed and the active mode may be set to the passive mode when the IMS registration fails or the driving of the timer ends.

In the mode setting processing step, IMS access information may be dynamically set based on the IMS subscription information when the IMS subscription information is received, and in the UE function step, its own interface address information may be registered in the IMS where its own interface address shall be different from interface address of the individual terminal.

The UE function step may use a globally routable UA URI (GRUU) as the interface address information.

The method for registering to an IMS may further include, when the IMS subscription information is received.

The method for registering to an IMS may be performed in a sharing IMS terminal.

According to the exemplary embodiments of the present invention, the following effects can be obtained by finding out the sharing IMS terminal capable of accessing the IMS based communication network and allowing the specific user to temporarily use the sharing IMS terminal.

First, the sharing IMS terminal can be used as the user terminal by detecting the sharing IMS terminal every time the location of the user is changed. Second, the apparatus or service can be shared in the ubiquitous network environment by allowing the user to occupy the detected sharing IMS terminal for a predetermined time. Third, the IMS of the related art can be easily applied by extending only the function of the IMS terminal while using the CSCF and SCC AS of the IMS of the related art.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram illustrating a method for controlling session mobility between terminals in the related art in an IMS.

FIG. 2 is a reference diagram for describing a problem of an IMS based communication network in the related art.

FIG. 3 is a conceptual diagram of an IMS based communication network system according to an exemplary embodiment of the present invention.

FIG. 4 is a conceptual diagram illustrating a process of registering information on a sharing IMS terminal in a local IP network.

FIG. 5 is an exemplified diagram of SIP URL information of a sharing IMS terminal 430 including an IP address.

FIG. 6 is an exemplified diagram of information stored in a DHCP server.

FIG. 7 is a diagram illustrating a procedure of allowing an individual IMS terminal to find out a sharing IMS terminal and use the sharing IMS terminal.

FIG. 8 is an exemplified diagram of IMS subscription information of an individual IMS terminal having an XML form.

FIG. 9 is a block diagram of an apparatus for controlling session mobility according to the exemplary embodiment of the present invention.

FIG. 10 is a flow chart illustrating a method for controlling session mobility of the apparatus for controlling session mobility illustrated in FIG. 9.

FIG. 11 is an exemplified diagram of an individual IMS terminal applied to an IMS based communication network system according to an exemplary embodiment of the present invention.

FIG. 12 is an exemplified diagram of a sharing IMS terminal applied to the IMS based communication network system according to the exemplary embodiment of the present invention.

FIG. 13 is a flow chart illustrating a method for registering an IMS.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. It is to be noted that in giving reference numerals to components of each of the accompanying drawing, like reference numerals refer to like elements even though the like components are shown in different drawings. Further, in describing exemplary embodiments of the present invention, well-known functions or constructions will not be described in detail since they may unnecessarily obscure the understanding of the present invention. In addition, exemplary embodiments of the Present invention will be described below, but the technical idea of the present invention is not limited or restricted thereto, and may be modified and variously performed by a person having ordinary skill in the art to which the present invention pertains.

When a user moves to a place at which a sharing IMS terminal is present, the user may access a local IF network through a WiFi connection. In this case, an individual INS terminal acquires address of a service discovery server present an user's location information in the local IP network from an AP. Next, the individual IMS terminal may query the service discovery server to find out an SIP URL address of a sharing IMS terminal. When the individual IMS terminal finds out the sharing IMS terminal, its own IMS subscription information is transmitted to the sharing IMS terminal. The sharing IMS terminal is dynamically registered in the IMS depending on the received IMS subscription information. When the process ends, the sharing IMS terminal has the same IMS subscription information as the individual IMS terminal, such that the session mobility control provided by the IMS may be applied as it is.

For moving a session between two terminals (session mobile source terminal and session mobile target terminal), a target terminal to which a session is moved needs to be first found out. In the IMS, when another terminal of a user is registered in the IMS, the session mobile target terminal may be found out by notifying the registered fact to the same IMS subscription information. In this case, a method for informing an SIP registration event is used.

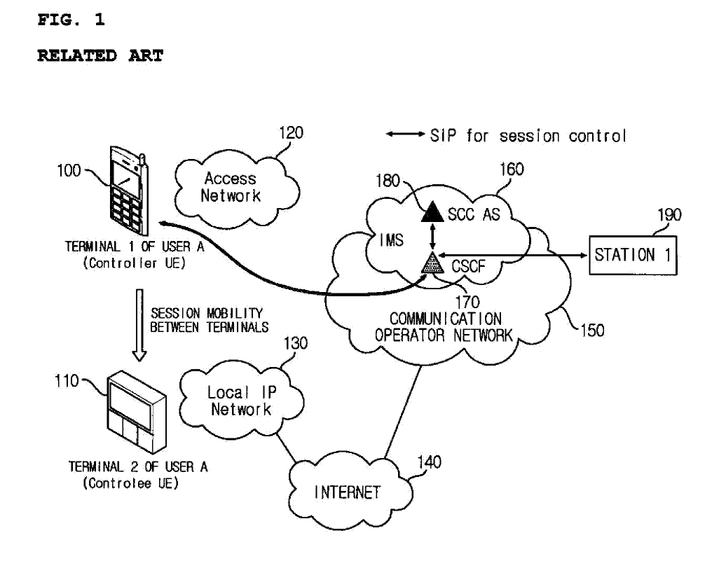

FIG. 1 is a conceptual diagram illustrating a method for controlling session mobility between terminals in the related art in an IMS. The following description will be made with reference to FIG. 1.

A user registers a terminal 1 100 and a terminal 2 110 in an IMS 160 of a communication operator network 150 using the same IMS subscription information. The terminal 1 100 of a user A is a mobile terminal carried by the user and accesses the IP based communication operator network 150 through a mobile access network 120. The IMS 160 performs a control based on an SIP so as for the terminal 1 100 to receive various multimedia services. In the IMS 160, a core network element that performs the control is a call session control function (CSCF) 170. The CSCF may be differentiated as a P-CSCF, an I-CSCF, and an S-CSCF according to the function. A station 1 190 may be another IMS terminal or a server that provides an IMS based multimedia service. In FIG. 1, it is assumed that the terminal 1 100 receives a streaming service from the station 1 190 under the control of the IMS.

It is assumed that the terminal 2 110 is another terminal of the user A and accesses the communication operator network 150 through a local IP network 130. The terminal 2 110 may pass through the Internet 140 at the time of accessing.

While a user comes home, the user wishes to seamlessly receive a service by changing a streaming service enjoying with the terminal 1 100 to the terminal 2 110. For this purpose, the user first needs to know whether the terminal 2 110 is present and the terminal is available. For this purpose, the user previously subscribes to an SIP registration event notification that is a service to notify the registered fact when another terminal of the user is registered. Under the assumption, the user may know whether the terminal 2 110 is present and available, and move a current progressing session to the terminal 2 110 by using the method for controlling a session between terminals.

According to the method for controlling session mobility of an IMS, a current terminal prior to moving a session becomes a controller UE and a terminal to which a session is moved becomes a controllee UE. The IMS provides various methods for controlling session mobility between terminals, such as adding and removing a media, and the like, rather than simply moving a session to another terminal and the control is performed by a session centralization and continuity application server (SCC AS) 180. However, the method for session mobility between the IMS terminals as described above causes a problem in that any terminal or a public terminal connected to the Internet may not be used as a target terminal for session mobility.

For example, it is assumed that a TV and a set-top box are present at home. It is assumed that the user A comes home while performing a video call and moves a current video call session to a TV. For implementing this, a TV needs to previously store subscription information on the IMS of the user A When a user B that is a wife of the user A wishes to move the video call session to a TV in the same situation, this will not be permitted.

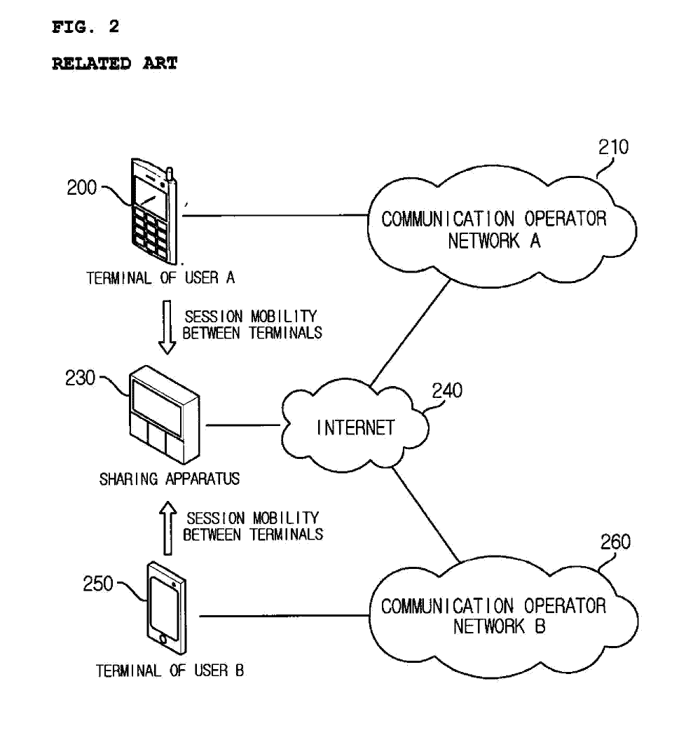

FIG. 2 is a reference diagram for describing a problem of an IMS based communication network in the related art. The following description will be made with reference to FIG. 2.

A terminal 200 of the user A is subscribed to a communication operator network A 210 and a terminal 250 of a user B is subscribed to a communication operator network B 260. A sharing apparatus 230 such as a TV used by a family at home is connected with the Internet 240. In this case, in order to receive the session mobility service between terminals provided from the IMS, the IMS subscription information of the user A or the IMS subscription information of the user B need to be set in the sharing apparatus 230. When the IMS subscription information of the user A is set, the user B may not use the sharing apparatus 230 as the terminal for session mobility. On the other hand, when the subscription information of the user B is set, the user A may not use the sharing apparatus 230 as the terminal for session mobility.

An IMS based terminal discovery method and a method for controlling session mobility of the related art have a problem in a ubiquitous network environment in which many apparatuses are connected through a network and these apparatuses may be shared and used by many users.

In order to solve the foregoing problem, the present invention proposes a method for allowing a user to temporarily register and use a sharing IMS terminal as his/her own terminal. Further, the present invention also proposes a method for finding out the sharing IMS terminal present at a place where a user moves by using a mobile terminal carried by a user.

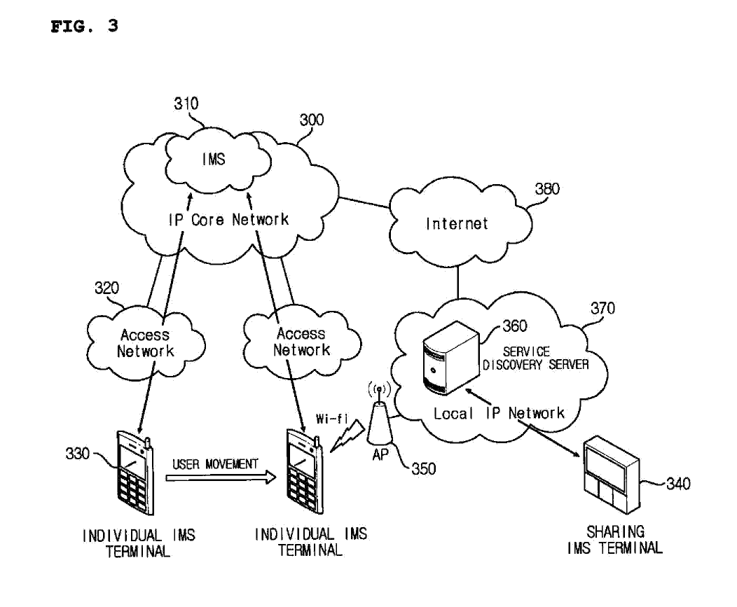

FIG. 3 is a conceptual diagram of an IMS based communication network system according to an exemplary embodiment of the present invention. The following description will be made with reference to FIG. 3.

A sharing IMS terminal 340 is a sharing terminal at a specific place. For example, the sharing IMS terminal may be a PC in a conference room, a TV in a living room at home, and the like and accesses the Internet 380 through a local IP network 370. Since the sharing IMS terminal 340 is a sharing apparatus that may be used by many users, the sharing IMS terminal 340 is connected with a network, but is not registered in the IMS of a specific communication network. For using the sharing IMS terminal 340, a user needs to first find out the presence and ability of the sharing IMS terminal 340. To this end, in the system, a service discovery server 360 is included in the local IP network 370.

The service discovery server 360 provides a function of enabling an apparatus or services present in the local IP network 370 to register their own information. The sharing IMS terminal 340 registers its own session initiation protocol (SIP) URL information and ability in the service discovery server 360. The registration needs to be performed before the user moves to a place at which the sharing IMS terminal 340 is present.

The local IP network 370 includes an access point 350 that provides a WiFi connection. The AP 350 includes a dynamic host configuration protocol (DHCP) server function. The DHCP server stores an address of the service discovery server 360 and place information (for example, conference room No. 2) of AP that is present on the local IP network 370 along with an IP address and a domain server address for a terminal accessed through the WiFi connection.

A user uses an individual IMS terminal 330 as a basic terminal and accesses an IP core network 300 provided by a communication network operator through an access network 320 as the user moves. In this case, the user receives various services such as a phone call, and the like, by the control of an IMS 310.

When the user moves to a place at which the sharing IMS terminal 340 is present, he/she may access the local IP network 370 through the WiFi connection. In this case, the individual IMS terminal 330 acquires the address of the service discovery server 360 and place information present in the local IP network 370 from the AP 350. Next, the individual IMS terminal 330 may query the service discovery server 360 to find out an SIP URL address of the sharing IMS terminal 340. When the individual IMS terminal 330 finds out the sharing IMS terminal 340, the individual IMS terminal 330 transfers its own subscription information to the sharing IMS terminal 340. The sharing IMS terminal 340 is dynamically registered in the IMS 310 depending on the received IMS subscription information. When the process ends, the sharing IMS terminal 340 has the same IMS subscription information as the individual IMS terminal 330, such that the session mobility control provided by the IMS may be applied as it is.

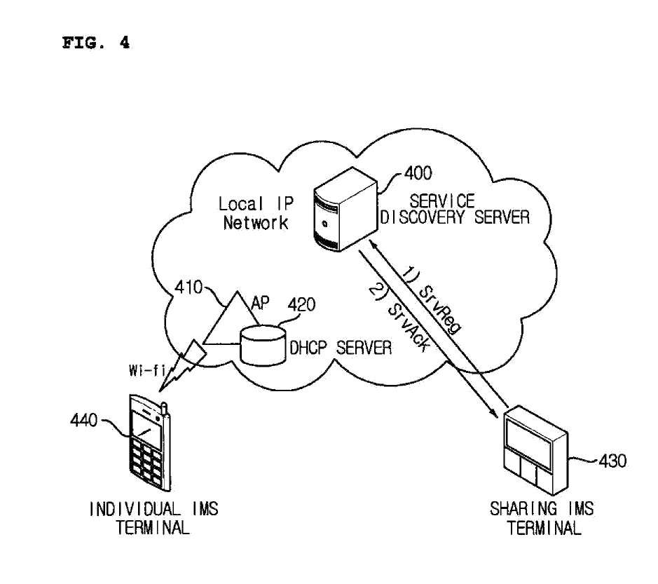

FIG. 4 is a conceptual diagram illustrating a process of registering information on the sharing IMS terminal in the local IP network. The following description will be made with reference to FIG. 4.

The local IP network is configured of an AP 410 that includes at least one sharing IMS terminal 430, a service discovery server 400 storing information on the sharing IMS terminal 430, and a DHCP server 420.

The service discovery server 400 is a service location protocol (SLP) based directory agent (DA).

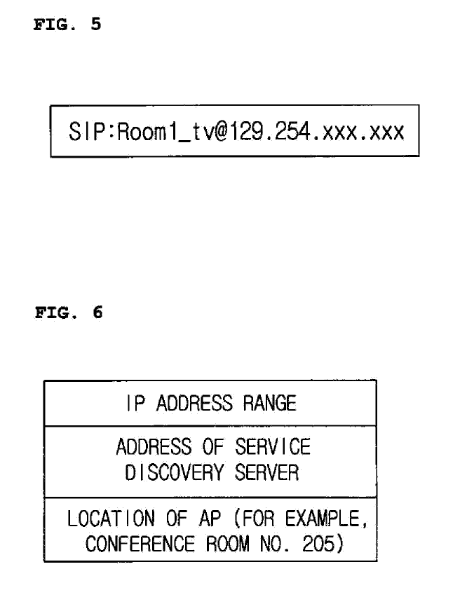

The sharing IMS terminal 430 includes an IMS user equipment (UE) function and an SLP service agent (SA) function. When the sharing IMS terminal 430 is not bound to a specific user, the sharing IMS terminal 430 has only its own IP address, SLP DA IP address information, and its own location information (for example, conference room No. 250) as basic information. The sharing IMS terminal 430 uses the information basically set to register its own location information along with the SIP URL information in the service discovery server 400 using an SLP protocol. In this case, a service type is designated as the ‘sharing IMS terminal’. FIG. 5 is an exemplified diagram of SIP URL information of the sharing IMS terminal 430 including an IP address.

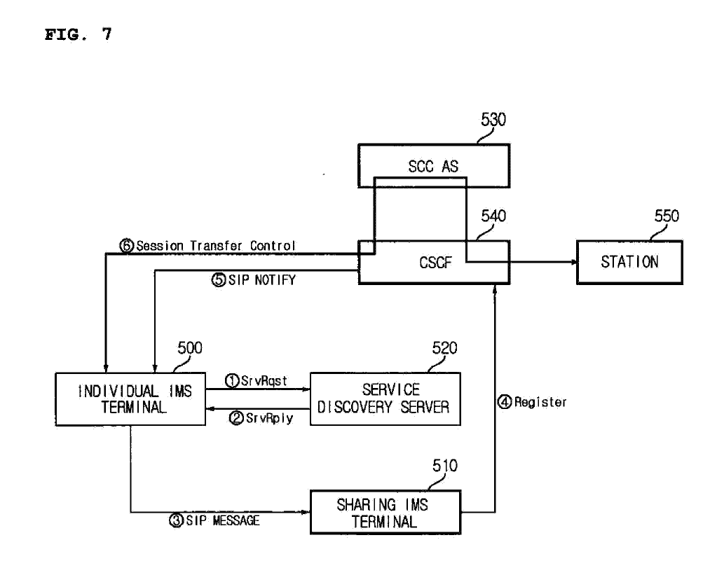

The DHCP server 420 is included in the AP 410 and stores information as illustrated in FIG. 6. When the DHCP server 420 is accessed by an individual IMS terminal 440 through the WiFi connection, the DHCP server 420 transfers the stored information to the individual IMS terminal 440.

FIG. 6 is an exemplified diagram of the information stored in the DHCP server.

FIG. 7 is a diagram illustrating a procedure of allowing the individual IMS terminal to find out the sharing IMS terminal and use the sharing IMS terminal. The following description will be made with reference to FIG. 7.

FIG. 7 illustrates a procedure that the IMS individual terminal accesses the WiFi network on a session mobility scenario between terminals, finds out the sharing IMS terminal through the service discovery server, and uses the terminal. In particular, FIG. 7 illustrates a scenario that an individual IMS terminal 500 finds out a sharing IMS terminal 510 at the place to which the user moves according to the foregoing description while performing a video call with a station 550 and moves a progressing session according to a method for controlling standardized IMS session mobility to the sharing IMS terminal 510.

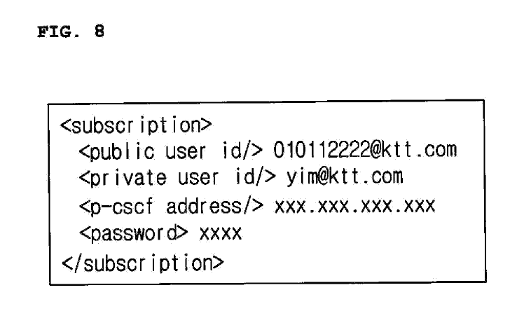

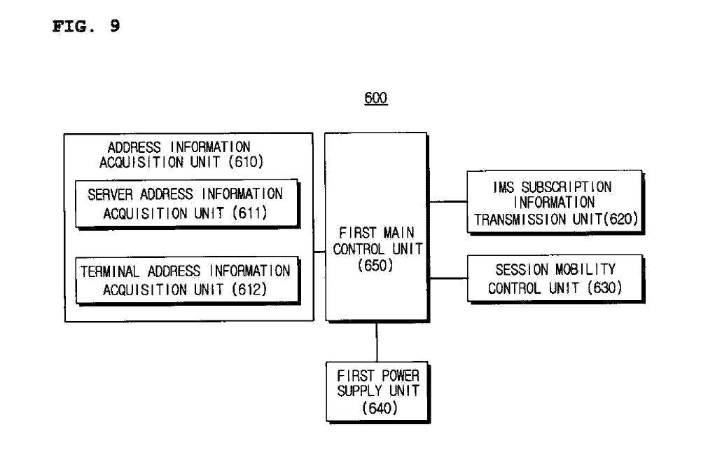

The individual IMS terminal 500 confirms whether the sharing IMS terminal available at a current location is present in a service discovery server 520 using SrvRqst (\textcircled{1}) and the service discovery server 520 makes a reply using SrvRply (\textcircled{2}). At the time of transmitting the SrvRqst, the service type needs to be designated as the ‘sharing INS terminal’ and the current location information acquired from the DHCP server needs to be included as an attribute value. The individual IMS terminal 500 acquires an SIP URL information of the sharing IMS terminal 510 by the SrvRply. The individual IMS terminal 500 transmits the IMS subscription information of the individual IMS terminal 500 to the sharing IMS terminal 510 (\textcircled{3}) by being included in an SIP message. FIG. 8 is an exemplified diagram of the IMS subscription information of the individual IMS terminal having an XML form.

The sharing IMS terminal 510 notifies a user that the IMS subscription information is received, through a screen or sound. In addition, the sharing IMS terminal 510 transmits a reply message to the individual IMS terminal 500. The sharing IMS terminal 510 uses the IMS registration information to dynamically set the IMS access information and performs a register procedure to the IMS (\textcircled{4}). The register implicitly represents the registration procedure of IMS and includes a register transmission and a reply of the SIP protocol. In this case, a globally routable UA URI (GRUU) of the individual IMS terminal 500 and the sharing IMS terminal 510 needs to be different. When the registration of the sharing IMS terminal 510 ends, the individual IMS terminal 500 knows the information on the sharing IMS terminal by receiving SIP notify depending on an IMS standard terminal finding mechanism (\textcircled{5}). Next, media present in the individual IMS terminal 500 may move to the sharing IMS terminal 510 according to the method for controlling IMS standard session mobility (\textcircled{6}).

Referring to the foregoing contents with reference to FIGS. 1 to 8, an apparatus, which is included in the individual IMS terminal to perform a session mobility control function, may be configured in a preferred form as follows. FIG. 9 is a block diagram of an apparatus for controlling session mobility according to the exemplary embodiment of the present invention. The following description will be made with reference to FIG. 9.

An apparatus 600 for controlling session mobility is included in an individual IMS terminal accessed by a user and is driven every time a location of the user is changed. The apparatus 600 for controlling session mobility includes an address information acquisition unit 610, an IMS subscription information transmission unit 620, a session mobility control unit 630, a first power supply unit 640, and a first main control unit 650.

The address information acquisition unit 610 performs a function of acquiring address information of a sharing IP multimedia subsystem available at a current location. The address information acquisition unit 610 may acquire a session initiation protocol (SIP) URL as address information of the sharing IMS terminal.

The address information acquisition unit 610 may include a server address information acquisition unit 611, and a terminal address information acquisition unit 612.

The server address information acquisition unit 611 performs a function of accessing an access point (AP) to acquire the address information of the service discovery server storing the information on the sharing INS terminals.

The terminal address information acquisition unit 612 performs a function of querying whether there is the sharing IMS terminal connected with a local network relating to current location information while transmitting the current location information to the service discovery server.

The terminal address information acquisition unit 612 performs a function of acquiring the address information of the sharing INS terminal connected with the local network from the service discovery server, when the terminal address information acquisition unit 613 receives a reply that there is the sharing IMS terminal connected with the local network.

The server address information acquisition unit 611 may also acquire location information along with the address information of the service discovery server. In this case, the query unit 612 may query whether the sharing IMS terminal is present only to the service discovery server located at the nearest distance to the query unit 612.

The IMS subscription information transmission unit 620 performs a function of transmitting its own IMS subscription information to the sharing IMS terminal based on the address information of the sharing IMS terminal. The IMS subscription information transmission unit 620 may transmit the IMS subscription information to the sharing IMS terminal by being included in the SIP message.

When the sharing INS terminal is dynamically registered in the IMS, the session mobility control unit 630 performs a function of moving the progressing session to the sharing IMS terminal based on the IMS subscription information.

The first power supply unit 640 performs a function of supplying power to each configuration unit configuring the apparatus 600 for controlling session mobility.

The first main control unit 650 performs a function of controlling the overall operation of each configuration unit configuring the apparatus 600 for controlling session mobility.

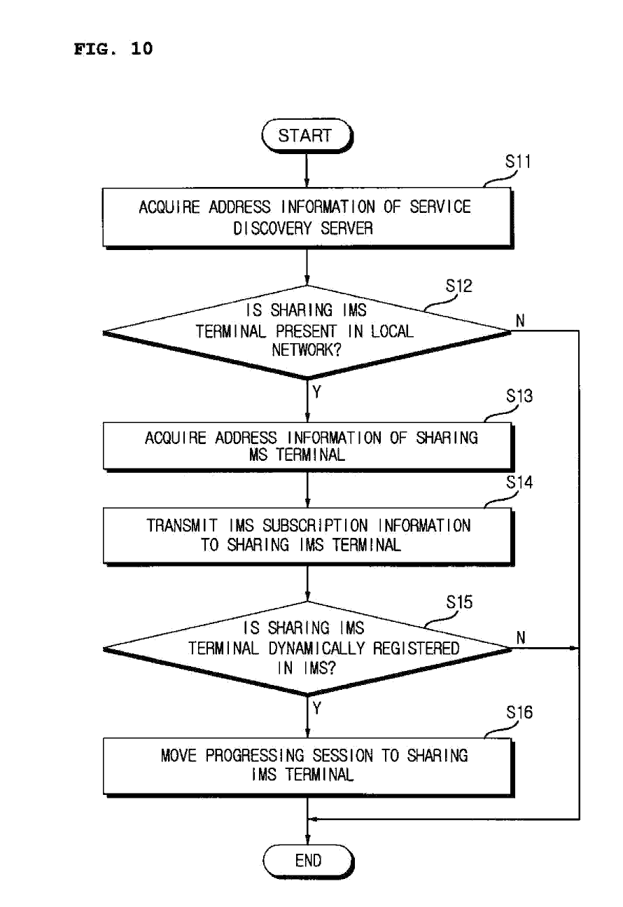

FIG. 10 is a flow chart illustrating a method for controlling session mobility of the apparatus for controlling session mobility illustrated in FIG. 9. The following description will be made with reference to FIG. 10.

First, the address information acquisition unit 610 acquires the address information of the sharing IMS terminal available at the current location. The description thereof will be provided below in more detail.

The server address information acquisition unit 611 accesses the access point (AP) to serve to acquire the address information of the service discovery server storing the information on the sharing IMS terminals (S11). Next, the terminal address information acquisition unit 612 queries whether there is the sharing IMS terminal connected with the local network relating to the current location information while transmitting the current location information to the service discovery server (S12). When a reply that there is the sharing IMS terminal connected with the local network is received, the terminal address information acquisition unit 612 acquires the address information of the sharing IMS terminal connected with the local network from the service discovery server (S13). Meanwhile, the server address information acquisition unit 611 may also acquire the location information along with the address information of the service discovery server at the time of performing step S11.

After step S13, the IMS subscription information transmission unit 620 transmits its own IMS subscription information to the sharing IMS terminal based on the address information of the sharing IMS terminal (S14). When the sharing IMS terminal is dynamically registered in the IMS (S15), the session mobility control unit 630 moves the progressing session to the sharing IMS terminal based on the IMS subscription information (S16).

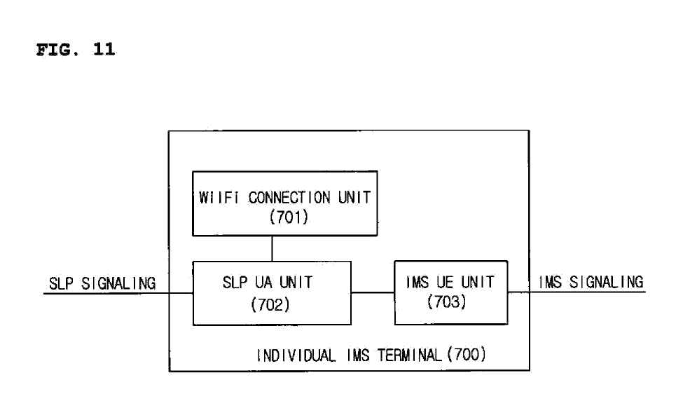

Next, an exemplary embodiment of an individual IMS terminal including the apparatus 600 for controlling session mobility described with reference to FIGS. 9 and 10 will be described. FIG. 11 is an exemplified diagram of the individual IMS terminal applied to an IMS based communication network system according to an exemplary embodiment of the present invention. The following description will be made with reference to FIG. 11.

A WiFi connection unit 701 senses a WiFi network and accesses the WiFi network. The WiFi connection unit 701 transmits the address and location information of the service discovery server, which is acquired while accessing the WiFi network, to an SLP UA unit 702.

The SLP UA unit 702 uses the address and location information of the service discovery server to acquire the SIP URL of the sharing IMS terminal.

An IMS UE unit 703 is a UE that is defined by an IMS standard. However, when the SLP UA unit 702 transmits the SIP URL address of the sharing IMS terminal, the SLP UA unit 702 extends to serve to transmit its own IMS registration information to the SIP URL of the sharing IMS terminal by being carried on the SIP message.

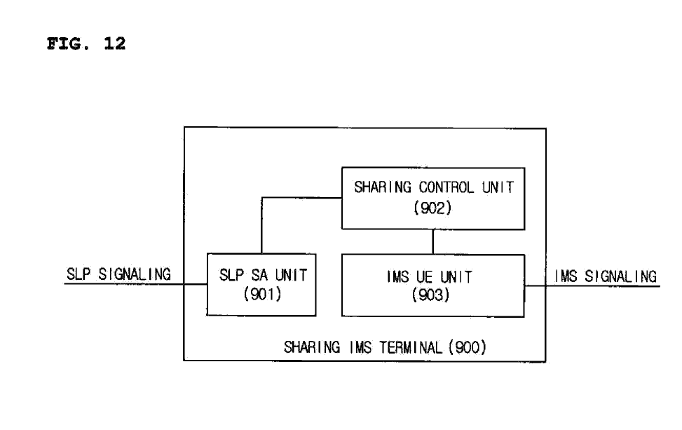

Next, an exemplary embodiment of the sharing IMS terminal to perform an IMS registration function. FIG. 12 is an exemplified diagram of the sharing IMS terminal applied to the IMS based communication network system according to the exemplary embodiment of the present invention. The following description will be made with reference to FIG. 12.

An SLP SA unit 901 performs a role of registering the sharing IMS terminal in the service discovery server. The SIP URL and the location information of the terminal that is the information required at the time of the registration is acquired from a sharing control unit 902.

An IMS UE unit 903 is operated in two modes. In the passive mode, the IMS is not registered. In the passive mode state, the SIP message transmitted by the individual IMS terminal may be received and when the SIP message is received, performs a function of extracting the IMS subscription information from the SIP message and transmitting the extracted IMS subscription information to the sharing control unit 902. When an activation request is received from the sharing control unit 902, the mode is converted into the active mode and the IMS registration is attempted to perform a normal role of an IMS UE. When the registration fails, the mode is converted into the passive mode again. When the IMS UE unit 903 is in the active mode, the IMS UE unit 903 performs the same function as a standard IMS UE.

When the sharing control unit 902 receives the IMS subscription information of the individual IMS terminal from the IMS UE unit 903, the sharing control unit 902 uses the information to set a P-CSCF address, public user ID information, private user ID information, coding information, and the like of the IMS UE and then transmits the activation request to the IMS UE. The sharing control unit 902 provides a maximum use time timer so as to prevent a monopoly of the sharing IMS terminal by one user and operates the timer after activating the timer. When the timer expires, an inactivation request is transmitted to the IMS UE unit 903. When the IMS UE unit 903 receives the inactivation request, all progressing calls end and the mode is converted into a passive mode. In addition, the IME UE unit 903 is automatically converted into the passive mode when a call ends by an SIP signaling procedure.

The sharing control unit 902 may be configured of a mode setting unit and a timer driving unit.

The mode setting unit has a passive mode value as a default value. When the IMS subscription information is received from an IMS subscription information receiving unit, the mode setting unit performs the following operations after the mode is converted into an active mode.

First, in the active mode, the IMS subscription information received from the IMS subscription information receiving unit is disregarded. Second, when a control message representing the failure of the IMS registration is received from the IMS registration unit, a current mode is converted into the passive mode. Third, when a control message representing an ending of a call (normal, abnormal) is received from the IMS registration unit, a current mode is converted into the passive mode. Fourth, when a control message representing the experiment of the timer is received from the timer driving unit, a current mode is converted into the passive mode. Fifth, a message for ending a call is transmitted to the UE unit included in the same terminal.

When a control message representing a call connection is received from the UE unit, the timer driving unit drives the timer. Further, the timer may not be limited by setting a timer value to 0. The timer driving unit notifies the mode setting unit when the timer expires.

The method for controlling session mobility between terminals based on the IMS in the related art has a limitation that the terminal participating in the session mobility needs to be the same user terminal. That is, there is a limitation that the user terminal needs to be subscribed to the IMS of the same communication network operator as the same registration information. This incurs the problem in that the terminals (for example, a TV at home, a PC in a public place) shared by many people may not be used as a terminal for moving a session. It is evident that the method for controlling session mobility between terminals based on the IMS in the related art restricts the service use experience of the user in the ubiquitous network environment in which many terminals are connected with the network and the terminal found at the current location of the user while the user moves may be dynamically used.

According to the configuration of the present invention, the user may easily find out the sharing terminal present at the moved spot and there is an advantage in that the sharing terminal may be used like the user's own terminal for a predetermined time. Further, there is an advantage in that the configuration of the present invention may be easily applied to the IMS network of the related art by using core network elements (CSCF and SCC AS) of the IMS of the related art as they are and extending only the function of the IMS terminal.

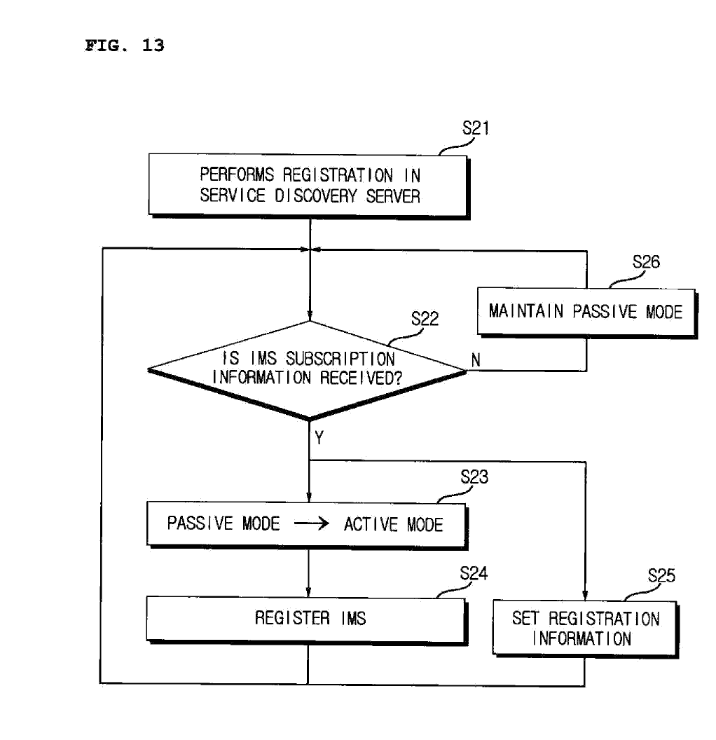

FIG. 13 is a flow chart illustrating a method for registering an IMS. The following description will be made with reference to FIG. 13.

First, the registration unit makes a registration of the sharing IMS terminal in the service discovery server based on its own address information and location information (S21).

Next, when the IMS subscription information of the individual IMS terminal is received (S22), the sharing control unit 902 sets a passive mode as an active mode (S23).

According to the present embodiment, the active mode means a state in which the sharing IMS terminal receives the IMS subscription from the individual IMS terminal to be registered in the server. On the other hand, the passive mode is a state that is not such a state and means a state capable of receiving the IMS subscription from the individual IMS terminal. As soon as the sharing IMS terminal receives the IMS subscription from the individual IMS terminal, the sharing IMS terminal becomes the active mode, such that the IMS subscription information from another individual terminal is disregarded. The conversion from the active mode to the passive mode may be caused by a registration failure in the IMS server, an expire of a timer value used to prevent a monopoly of one user at the time of normal ending after the use of a service due to the session mobility after registration, the abnormal ending of a call, and the like.

When the mode is set as the active mode, the IMS UE unit 903 performs the IMS registration (S24). The IMS UE unit 903 may register its own interface address to the IMS where its own interface address shall be different from interface address of the individual terminal. The IMS UE unit 903 may use the globally routable UA URI (GRUU) as the interface address information.

When the IMS registration is performed, the sharing control unit 902 drives the timer and when the IMS registration fails or the driving of the timer ends, the sharing control unit 902 sets the active mode as the passive mode.

Meanwhile, when the IMS subscription information of the individual IMS terminal is not received (S22), the passive mode that is a default value is maintained (S26).

Meanwhile, when the IMS subscription information is received, the mode setting processing unit sets various information on a UE, a public user, and a private user based on the IMS subscription information (S25). Further, when the IMS subscription information is received, the mode setting processing unit dynamically sets the IMS access information based on the IMS subscription information (S25).

Meanwhile, when the IMS subscription information is received, the notification unit may notify the individual IMS terminal of the fact that the IMS subscription information is received so as to be confirmed by a user. The notification unit may perform the function after step S22.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for controlling session mobility, comprising:
an address information acquisition unit that acquires address information of a sharing IP multimedia subsystem (IMS) terminal available at a current location;
an IMS subscription information transmission unit that transmits its own IMS subscription information to the sharing IMS terminal based on the address information of the sharing IMS terminal; and
a session mobility control unit that moves a progressing session to the sharing IMS terminal when the sharing IMS terminal is dynamically registered in the IMS based on the IMS subscription information.

2. The apparatus of claim 1, wherein the address information acquisition unit includes:
a server address information acquisition unit that accesses an access point (AP) to acquire address information of a service discovery server storing the information on sharing IMS terminals; and
a terminal address information acquisition unit that queries whether there is the sharing IMS terminal connected with a local network relating to current location information while transmitting the current location information to the service discovery server, and when a reply that there is the sharing IMS terminal connected with the local network is received, that acquires address information of the sharing IMS terminal connected with the local network from the service discovery server.

3. The apparatus of claim 2, wherein the server address information acquisition unit acquires location information along with the address information of the service discovery server.

4. The apparatus of claim 1, wherein the address information acquisition unit acquires a session initiation protocol (SIP) URL as the address information of the sharing IMS terminal or
the IMS subscription information transmission unit transmits the IMS subscription information to the sharing IMS terminal by being included in an SIP message.

5. The apparatus of claim 1, wherein the apparatus for controlling session mobility is included in an individual IMS terminal accessed by a user.

6. The apparatus of claim 5, wherein the apparatus for controlling session mobility is driven every time the location of the user is changed.

7. A method for controlling session mobility, comprising:
acquiring address information of a sharing IP multimedia subsystem (IMS) terminal available at a current location;
transmitting its own IMS subscription information to the sharing IMS terminal based on the address information of the sharing IMS terminal; and
moving a progressing session to the sharing IMS terminal when the sharing IMS terminal is dynamically registered in the IMS based on the IMS subscription information.

8. The method of claim 7, wherein the acquiring of the address information includes:
accessing an access point (AP) to acquire address information of a service discovery server storing the information on sharing IMS terminals; and
acquiring address information of the sharing IMS terminal connected with the local network from the service discovery server, when a reply that there is the sharing IMS terminal connected with the local network is received, after querying whether there is the sharing IMS terminal connected with a local network relating to current location information while transmitting the current location information to the service discovery server.

9. An apparatus for registering to an IMS, comprising:
when IMS subscription information of an individual IMS terminal is received, a mode setting control unit that sets a passive mode as an active mode; and
a user equipment (UE) unit that performs IMS registration when being set as the active mode.

10. The apparatus of claim 9, further comprising:
when the IMS subscription information is received, a mode setting processing unit that sets various information on a UE, a public user identity, and a private user identity based on the IMS subscription information,
wherein the mode setting control unit drives a timer when the IMS registration is performed and sets the active mode into the passive mode when the IMS registration fails or the driving of the timer ends.

11. The apparatus of claim 9, wherein the mode setting processing unit dynamically sets IMS access information based on the IMS subscription information when the IMS subscription information is received, and
the UE unit registers its own interface address information to the IMS where its own interface address shall be different from interface address of the individual terminal.

12. The apparatus of claim 11, wherein the UE unit uses a globally routable UA URI (GRUU) as the interface address information.

13. The apparatus of claim 9, wherein the apparatus for registering to an IMS is included in a sharing IMS terminal.

14. A method for registering an IMS, comprising:
when IMS subscription information of an individual IMS terminal is received, a mode setting control step of setting a passive mode as an active mode; and
a UE function step of performing IMS registration when the mode is set as the active mode.

15. The method of claim 14, further comprising:
when the IMS subscription information is received, mode setting processing step of setting various information on a UE, a public user identity, and a private user identity based on the IMS subscription information,
wherein in the mode setting control step, a timer is driven when the IMS registration is performed and the active mode is set as the passive mode when the IMS registration fails or the driving of the timer ends.

16. The method of claim 14, wherein in the mode setting processing step, IMS access information is dynamically set based on the IMS subscription information when the IMS subscription information is received, and in the UE function step, its own interface address information are registered in the IMS where its own interface address shall be different from interface address of the individual terminal.
